(19) United States
(12) Patent Application Publication
(10) Pub. No.: US 2014/0265939 A1
(43) Pub. Date: Sep. 18, 2014

(54) Dual Polarity Transmission Line

(71) Applicant: COMPACT PARTICLE ACCELERATION CORPORATION, Livermore, CA (US)

(72) Inventor: Cameron Hettler, Livermore, CA (US)

(73) Assignee: Compact Particle Acceleration Corporation, Livermore, CA (US)

(21) Appl. No.: 13/798,993

(22) Filed: Mar. 13, 2013

(51) Int. Cl. H05H 3/04

(52) U.S. Cl. CPC H05H 3/04
USPC 315/505

(57) ABSTRACT

A dual polarity transmission line structure that can provide high-voltage pulses of very short duration, such as can be incorporated in a compact accelerator of charged particles as well as other applications, is presented. The exemplary structure has a transmission line, formed a pair of conducting strip with dielectric between them, and a pair of switches. Each of the switches is connected between one of the conducting strips and a charging section, so that when the switches are off, the capacitor plates that are respectively connected to a first and a second of the switches are charged to voltage levels above and below the level at which the first and second conductive strips are set. A pulse is then generated by turning on the switches. Multiple such structures can be stacked to provide a pulse generating system.

### BACKGROUND

1. Field of the Invention

This invention relates generally to circuitry for supplying electrical pulses, such as would be in linear accelerators.

2. Background Information

Particle accelerators are used to increase the energy of electrically charged atomic particles. In addition to their use for basic scientific study, particle accelerators also find use in the development of nuclear fusion devices and for medical applications, such as cancer therapy. An example is described in U.S. Pat. No. 7,173,385. In order to accelerate the particles, a series of high frequency, high voltage pulse are applied along the axis of the accelerator. The greater the voltage and the greater frequency, the more effective the accelerator. To make such devices more practical, they should also be smaller is size and more efficient. Consequently, there is an ongoing need to make particle accelerators more powerful, more compact, and more efficient.

### SUMMARY OF THE INVENTION

According to a first set of general aspects, a structure for providing an electromagnetic pulse includes a transmission line, first and second switches, and a charging section. The transmission line includes: a first planar conductive strip; a second planar conductive strip parallel to the first planar conductive strip; and a dielectric strip that fills the space between the first and second planar conducting strip. The first and second switches each have first and second terminals, where the first terminals of the first and second switches are respectively connected to the side of the first and second planar conducting strips opposite the dielectric strip at a first end of the transmission line. The charging section includes one or more capacitors, where the second terminals of the first and second switches are respectively connected to first and second capacitor plates of the charging sections. When the switches are off, the first and second plates are respectively charged to voltage levels above and below the level at which the first and second conductive strips are set.

According another set of aspects, a pulse generating system has a plurality of pulse generating sections. Each pulse generating sections has a transmission lines, first and second switches, and a charging section. The transmission line has a first planar conductive strip and a second planar conductive strip parallel to the first planar conductive strip. The first and second planar conducting strips respectively end in first and second annular electrodes aligned along the axis of the pulse generating system at a first end of the transmission line and a dielectric strip that fills the space between the first and second planar conducting strip. The first and second switches each have first and second terminals, where the first terminals of the first and second switches are respectively connected to the side of the first and second planar conducting strips opposite the dielectric strip at the end of the transmission line without the annular electrodes. The charging section includes one or more capacitors, where the second terminals of the first and second switches are respectively connected to first and second capacitor plates of the charging sections. When the switches are off, the first and second plates are respectively charged to voltage levels above and below the level at which the first and second conductive strips are set. The pulse generating sections are arranged so that the annular electrodes and at least a portion of transmission lines adjacent thereto are stacked one upon another in the direction of the axis of the pulse generating system, extending radially away from the axis of the pulse generating system, and with the pulse generating sections splayed out axially from the end of the transmission line sections with the switches.

Various aspects, advantages, features and embodiments of the present invention are included in the following description of exemplary examples thereof, which description should be taken in conjunction with the accompanying drawings. All patents, patent applications, articles, other publications, documents and things referenced herein are hereby incorporated herein by this reference in their entirety for all purposes. To the extent of any inconsistency or conflict in the definition or use of terms between any of the incorporated publications, documents or things and the present application, those of the present application shall prevail.

### BRIEF DESCRIPTION OF THE DRAWINGS

FIG. 1 illustrates an oscillating blumlein structure for generating a pulse.

FIG. 2 schematically illustrate an exemplary embodiment of a dual polarity transmission line.

FIG. 3 shows a module incorporating a dual polarity transmission line and a charging portion.

FIG. 4 illustrates a stacking of the modules for the embodiment of FIG. 3.

### DETAILED DESCRIPTION

The following presents a dual polarity transmission line structure that can provide high-voltage pulses of very short duration, such as can be incorporated in a compact accelerator of charged particles as well as other applications that need a pulsed, high-voltage energy source, such as a radar transmitter or MRI and CT machines, for example, or application to lasers that use short, high voltage pulses for operation. A number of designs, including blumlein structures, that can be used in linear accelerators and other applications are given in US patent publication number 2012-0146553 and U.S. patent application Ser. Nos. 13/352,187, 13/610,051, and 13/626,648; however, in many cases the dual polarity transmission line presented here can have a number of advantages.

For example, by way of comparison, FIG. 1 illustrates a blumlein structure that is similarly used for generating high-voltage pulses. The blumlein structure includes a top conducting strip 101 and a bottom conduction strip 103 that are respectively above and below a middle conducting strip 106 and which connected at the right end. The top strip 101 is connected to the middle conducting 105 strip through a switch SW 109. Here, the switch SW 109 can be an optically activated switch that is here placed between the top and the central conducting strips. The rest of the space between the conducting strips 101, 103 and 105 is then filled with a dielectric D 107. (More detail on this structure and variations of it are given in more detail in US patent publication number 2012-0146553 and U.S. patent application Nos. 13/610,051 and 13/626,648.)

To generate a pulse, central conducting plate is charged to a voltage +V while holding the outer plates at ground. The switch is then closed. A pulse then move off in either direction (P1, P2), with the left moving wave returning back to form the combined output pulse of amplitude V. This oscillating blumlein structure uses current to generate both of P1 and P2, where the P2 current moving off to the left does not contribute to the initial pulse; also, the double layer structures causes each blumlein to be half-again as thick (1.5 mm in this example) as just top layer.

FIG. 2 is as schematic illustration of a dual polarity transmission line arrangement that can eliminate the unused current and reduce the thickness inherent in the blumlein structure, as well as splitting the switching load. A transmission line is formed of a firm of conducting strips 201 and 203, with the space in between filled with dielectric D 205. A first switch SW1 207 is has one of its contacts connected on end the top conducting strip 201 and a second switch SW2 209 has one of its contacts connected on end the bottom conducting strip 203. By holding the conduction strips of the transmission line at ground, while placing voltages +V and −V respectively across the switches SW1 207 and SW2 209, when these switches are closed and begin to conduct a pulse of 2V will move down the transmission line to the right. Under this arrangement, of all the current is contributing to the first electromagnetic pulse. Also, the transmission line portion is thinner as it of a single layer. (The pair of switches add thickness when such transmission lines are stacked, but this is considered below with respect to FIG. 4.) Thus, to achieve the same electric field at the right end of the transmission line, the blumlein structure of FIG. 1 would require something like twice the switch voltage and switch current relative to the dual polarity transmission line structure of FIG. 2.

With respect to the switches, the exemplary embodiments use an optically activate switch, such as that described in: G. Caporaso, “New Trends in Induction Accelerator Technology”, Proceeding of the International Workshop on Recent Progress in Induction Linacs, Tsukuba, Japan, 2003; G. Caporaso, et. al., Nucl Instr. and Meth. in Phys. B 261, p. 777 (2007); G. Caporaso, et. al., “High Gradient Induction Accelerator”, PAC'07, Albuquerque, June 2007; G. Caporaso, et. al., “Status of the Dielectric Wall Accelerator”, PAC'09, Vancouver, Canada, May 2009; J. Sullivan and J. Stanley, “6H-SiC Photoconductive Switches Triggered Below Bandgap Wavelengths”, Power Modulator Symposium and 2006 High Voltage Workshop, Washington, D.C. 2006, p. 215 (2006); James S. Sullivan and Joel R. Stanley, “Wide Bandgap Extrinsic Photoconductive Switches” IEEE Transactions on Plasma Science, Vol. 36, no. 5, October 2008; and Gyawali, S. Fessler, C. M. Nunnally, W. C. Islam, N. E., “Comparative Study of Compensated Wide Band Gap Photo Conductive Switch Material for Extrinsic Mode Operations”, Proceedings of the 2008 IEEE International Power Modulators and High Voltage Conference, 27-31 May 2008, pp. 5-8. More detail on illumination techniques for such switches is described in US patent publication number 2012-0146553 and U.S. patent application Nos. 61/680,782 and 13/610,069.

The single transmission line structure of FIG. 2 includes two switches, SW1 207 and SW2 209. Generally, operating switches in series can be difficult; however, operating the switches with opposite charging voltages effectively places the switches in series (half-bridge architecture) without the negative effects by balancing of the load current and voltage. FIG. 3 is an example of a module structure for the dual polarity transmission line and charging section.

To the right of FIG. 3 is a portion of the transmission line portion, including conductive strips 301 and 303 with the dielectric area 305 in between, which then continues off to the right. Each of the conductive strips is then connected to one terminal of one of the switches. Here the top contact of switch SW1 307 is connected by lead 311 to the top conducting plate 301 and the bottom contact of SW2 309 is connect by lead 313 to the bottom conducting strip 303. The voltages V+ and V− are then built up on first and second capacitor plates, respectively 315 and 317, of a charging section. Here, two separate capacitors are used, but share a common second plate 319 that is set to ground, where the region between the plates is filled with a dielectric that can be the same as or different from that used in the transmission line section. The bottom contact of switch SW1 307 is then connected to the upper plate 315 and the top contact of the switch SW2 309 is connected to the lower plate 317. Once the capacitors of the charging section are charged up, the switches SW1 307 and SW2 309 can illuminated at the same time to generate a pulse.

FIG. 3 is one specific arrangement of the charging section, but other arrangements can be used. For instance, although FIG. 3 uses two capacitors, they share a common plate, but more generally these capacitors can be separate. Alternately, a single capacitor can be used, such as would be in FIG. 3 with the central plate 319 removed. With respect to the voltage levels, here these are symmetrically above and below the level the transmission line is held before the switches are tripped, which is here at ground. More generally, the charging section can include one or more capacitors, where the second terminals of the first and second switches are respectively connected to first and second capacitor plates of the charging sections, and where, when the switches are off, the first and second plates are respectively charged to voltage levels above and below the level at which the first and second conductive strips are set.

A pulse generating system, such as a linear accelerator, will often stack multiple individual pulse generating sections. The thinness of the transmission line portion of the structure of FIGS. 2 and 3 allows for a relatively compact stack. Although the switch portion is thicker, these pairs can by splayed out so as to not position one over the other. This is similar a number of respects to what is done in U.S. patent application Ser. No. 13/626,648 for transmission line transformers. FIG. 4 illustrates a module made up of a stack of four dual polarity transmission lines, where several such modules can then be combined into system.

FIG. 4 shows a top view of four dual polarity transmission lines such as shown from the side in FIG. 3. The top most dual polarity transmission line's top conducting strip 401-1 is formed over the dielectric 405-1 and ends in annular electrode, or equilibration ring, 421-1. The transmission portions for another three units are then arranged underneath. The axis of the accelerator then runs through the rings perpendicularly into or out of the page. The switch ends then splay out axially at the other end. For instance, for the top most unit, the switch 401-1 has its bottom contact connected to the top-most capacitor plate 415-1 and its top contact connected to the conductive strip 401-1 by way of the lead 411-1. It also allows for the switches to have free space around their top surface due to a gap between layers, allowing for switch illumination from the contact side. Further, this arrangement reduces the need for relying on oil bathes for the system.

Depending on the application, the sort of dual polarity transmission line described here can have a number of potential advantages. The structure illustrated in FIG. 3 can be made as a double-sided printed circuit board, as it lacks the sort of buried layer found in the central conducting strip of the blumlein, for example. Also, there is an advantage in the conducting strips of the transmission lines and the equilibration rings are all in a single unit, so that no potting, or encapsulation, is needed between components and, as the overall change level can be lower, it can be operated in air.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application, to thereby enable others skilled in the art to best utilize the invention in various embodiments and with various modifications as are suited to the particular use contemplated. It is intended that the scope of the invention be defined by the claims appended hereto.

It is claimed:

1. A structure for providing an electromagnetic pulse, comprising:
a transmission line including:
a first planar conductive strip;
a second planar conductive strip parallel to the first planar conductive strip; and
a dielectric strip that fills the space between the first and second planar conducting strip;
first and second switches each having first and second terminals, where the first terminals of the first and second switches are respectively connected to the side of the first and second planar conducting strips opposite the dielectric strip at a first end of the transmission line; and
a charging section including one or more capacitors, where the second terminals of the first and second switches are respectively connected to first and second capacitor plates of the charging sections, and wherein, when the switches are off, the first and second plates are respectively charged to voltage levels above and below the level at which the first and second conductive strips are set.

2. The structure of claim 1, wherein the first and second capacitor plates are first and second plates of the same capacitor.

3. The structure of claim 1, wherein the first capacitor plate the first plate of a first capacitor and the second plate is the first plate of a second capacitor.

4. The structure of claim 3, where the second plate of the first capacitor and the second plate of the second capacitor are set at the level at which the first and second conductive strips are set when the switches are off.

5. The structure of claim 1, wherein the first and second switches are light activated.

6. The structure of claim 1, wherein the first and second planar conducting strips respectively end in first and second annular electrodes at the second ends thereof.

7. The structure of claim 6, wherein the first and second annular electrodes are aligned along the axis of a particle accelerator.

8. The structure of claim 1, wherein the level at which the first and second conductive strips are set when the switches are off is ground.

9. The structure of claim 8, wherein the first and second plates are respectively charged to a voltage level V and a voltage level −V.

10. The structure of claim 1, wherein the width of the conductive strips is less than of the capacitor plates.

11. A pulse generating system, comprising:
a plurality of pulse generating sections, each pulse generating section including
a transmission line having:
a first planar conductive strip;
a second planar conductive strip parallel to the first planar conductive strip, wherein the first and second planar conducting strips respectively end in first and second annular electrodes aligned along the axis of the pulse generating system at a first end of the transmission line; and
a dielectric strip that fills the space between the first and second planar conducting strip;
first and second switches each having first and second terminals, where the first terminals of the first and second switches are respectively connected to the side of the first and second planar conducting strips opposite the dielectric strip at the end of the transmission line without the annular electrodes; and
a charging section including one or more capacitors, where the second terminals of the first and second switches are respectively connected to first and second capacitor plates of the charging sections, and wherein, when the switches are off, the first and second plates are respectively charged to voltage levels above and below the level at which the first and second conductive strips are set,
wherein the pulse generating sections are arranged so that the annular electrodes and at least a portion of transmission lines adjacent thereto are stacked one upon another in the direction of the axis of the pulse generating system, extending radially away from the axis of the pulse generating system, and with the pulse generating sections splayed out axially from the end of the transmission line sections with the switches.

12. The of claim 11, wherein the first and second capacitor plates for each of the pulse generating sections are first and second plates of the same capacitor.

13. The pulse generating system of claim 11, wherein, for each of the pulse generating sections, the first capacitor plate the first plate of a first capacitor and the second plate is the first plate of a second capacitor.

14. The pulse generating system of claim 13, where the second plate of the first capacitor and the second plate of the second capacitor are set at the level at which the first and second conductive strips are set when the switches are off.

15. The pulse generating system of claim 11, wherein the switches are light activated.

16. The pulse generating system of claim 11, wherein, for each of the pulse generating sections, the level at which the first and second conductive strips are set when the switches are off is ground.

17. The pulse generating system of claim 16, wherein the first and second plates are respectively charged to a voltage level V and a voltage level −V.

18. The pulse generating system of claim 11, further including:
a light source connected to selectively illuminate the switches, where the first and second switches of each pulse generating section are illuminated in unison, and wherein the switches of the different ones of the pulse generating sections are illuminated sequentially along the direct of the axis of the pulse generating system.

19. The pulse generating system of claim 18, wherein the light source includes a laser.

20. The pulse generating system of claim 11, wherein the pulse generating system is a particle accelerator.
